(19) United States
(12) Patent Application Publication
(10) Pub. No.: US 2026/0170555 A1
(43) Pub. Date: Jun. 18, 2026

(54) AUTOMATED TECHNICAL DEBT EVALUATION AND SCORING USING ARTIFICIAL INTELLIGENCE

(71) Applicant: TEACHERS INSURANCE AND ANNUITY ASSOCIATION OF AMERICA, New York, NY (US)

(72) Inventors: Sonam Jha, Skillman, NJ (US); Rares Ioan Almasan, Paradise Valley, AZ (US); Sriram Venkatesan, Princeton Junction, NJ (US); Sastry Vsm Durvasula, Phoenix, AZ (US); Swatee Singh, Livingston, NJ (US); Thomas Matthew Verutes, Rockville Centre, NY (US); Geeta Pyne, San Jose, CA (US)

(21) Appl. No.: 18/981,392

(22) Filed: Dec. 13, 2024

(51) Int. Cl. G06Q 40/03; G06Q 10/0639

(52) U.S. Cl. CPC G06Q 40/03; G06Q 10/06393

(57) ABSTRACT

A computing system evaluates and manages technical debt by collecting data, determining coding signals, receiving inputs, assessing business capabilities, evaluating these using a scoring system, and generating a tech debt score. A method involves collecting data, determining coding signals, receiving inputs, assessing business capabilities, evaluating these with a scoring system, and generating a tech debt score. A non-transitory computer-readable medium includes instructions for performing these operations to evaluate and manage technical debt.

### FIELD OF THE INVENTION

The present aspects relate to assessing, identifying, and tracking technical debt within a technology ecosystem, and more particularly, to utilizing artificial intelligence and neural networks to forecast, predict, and classify technical debt, such as analyzing coding signals that define the technical debt score.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In the rapidly evolving landscape of technology, organizations face significant challenges in managing their technological infrastructure. This includes the task of identifying and addressing technical debt, which encapsulates not only the immediate deficiencies in software development practices, such as suboptimal design, code, and infrastructure but also broader issues like inadequate security measures and inefficient data management. The concept of technical debt extends to encompass the readiness for disaster recovery and the overall preparedness of business operations. The presence of technical debt can severely impede the efficiency and productivity of development teams, forcing them to allocate valuable time and resources to rectify existing issues rather than focusing on the delivery of new business functionalities.

Current approaches to managing technical debt require a considerable investment in terms of time and tools. This process is not only complex but also costly, making it a significant burden for organizations. According to industry reports, such activities can consume a substantial portion of an organization's technology budget and occupy a significant amount of technology professionals'time. The lack of a standardized procedure for quantifying and addressing technical debt further complicates the situation, hindering the ability of organizations to effectively prioritize and manage their technological investments.

Given these challenges, there are opportunities to address technical debt by reducing the dependency on informal assessments and allowing organizations to more effectively allocate their resources towards innovation and development.

### BRIEF SUMMARY OF THE INVENTION

In one aspect, a computing system for evaluating and managing technical debt within a technology ecosystem includes: (1) one or more processors; and (2) one or more memories storing instructions that, when executed by the processor, cause the system to: (a) collect, via the one or more processors, data from a technology ecosystem, including software and hardware platforms, tools, and processes; (b) determine, via the one or more processors, coding signals from coding practices, including code complexity and coding standards adherence; (c) receive, via the one or more processors, inputs from one or both of (i) a technical debt assessment system and (ii) an organizational redesign system, to inform a technology ecosystem assessment; (d) determine, via the one or more processors, business capabilities including functional abilities and processes of a business; (e) evaluate, via the one or more processors, the collected data, derived coding signals, inputs, and business capabilities using a scoring system; and (f) generate a tech debt score based on the evaluation, wherein the tech debt score represents the technical debt of the technology ecosystem.

In another aspect, a method for evaluating and managing technical debt within a technology ecosystem includes: (1) collecting, by one or more processors, data from a technology ecosystem, including software and hardware platforms, tools, and processes; (2) determining, by the one or more processors, coding signals from coding practices, including code complexity and coding standards adherence; (3) receiving, by the one or more processors, inputs from one or both of (i) a technical debt assessment system and (ii) an organizational redesign system, to inform a technology ecosystem assessment; (4) determining, by the one or more processors, business capabilities including functional abilities and processes of a business; (5) evaluating, by the one or more processors, the collected data, derived coding signals, inputs, and business capabilities using a scoring system; and (6) generating, by the one or more processors, a tech debt score based on the evaluation, wherein the tech debt score represents the technical debt of the technology ecosystem.

In yet another aspect, a non-transitory computer-readable medium includes instructions that, when executed by one or more processors of a computing system, cause the system to perform operations comprising: (1) collecting data from a technology ecosystem, including software and hardware platforms, tools, and processes; (2) determining coding signals from coding practices, including code complexity and coding standards adherence; (3) receiving inputs from one or both of (i) a technical debt assessment system and (ii) an organizational redesign system, to inform a technology ecosystem assessment; (4) determining business capabilities including functional abilities and processes of a business; (5) evaluating the collected data, derived coding signals, inputs, and business capabilities using a scoring system; and (6) generating a tech debt score based on the evaluation, wherein the tech debt score represents the technical debt of the technology ecosystem.

Advantages will become more apparent to those of ordinary skill in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof.

There are shown in the drawings arrangements which are presently discussed, it being understood, however, that the present embodiments are not limited to the precise arrangements and instrumentalities shown, wherein:

FIG. 1 depicts a technical debt and quantification computing environment for assessing, identifying, and tracking technical debt within a technology ecosystem by analyzing code repositories, application architecture diagrams, and process flows against a well-architected framework and technology ecosystem guidelines, according to some aspects.

FIG. 2 depicts a computer-implemented method for evaluating and managing technical debt within a technology ecosystem, according to some aspects.

FIG. 3 illustrates a flow diagram representing a computer-implemented method for generating a technology landscape overview within a technology environment, according to some aspects.

FIG. 4 depicts a flow diagram that outlines a method for processing coding signals through a neural network and generating a report based on the classification of those signals, according to some aspects.

FIG. 5 depicts a flow diagram illustrating a method for generating artificial intelligence (AI) models based on various business-related inputs, according to some aspects.

FIG. 6 illustrates a flow diagram for a method, which is designed for processing an input and generating an output using artificial intelligence and machine learning techniques, according to some aspects.

FIG. 7 depicts an output system for evaluating and managing technical debt within a technological or business environment, according to some aspects.

FIG. 8A depicts a block-flow diagram outlining a method for building and applying an artificial intelligence model, specifically a language learning model (LLM), according to some aspects.

FIG. 8B illustrates a neural network-based model architecture for processing and analyzing data related to technological deb, according to some aspects.

### DETAILED DESCRIPTION

In the rapidly evolving landscape of technology, organizations are tasked with the continuous challenge of innovating while efficiently managing their technological infrastructure. Achieving a balance between these objectives is crucial for maintaining competitiveness, agility, and the ability to swiftly adapt to market changes. However, organizations often encounter the significant hurdle of technical debt, which includes issues such as suboptimal design, outdated code, inadequate infrastructure, security vulnerabilities, and inefficient data management. These challenges not only hinder the productivity of development teams but also pose risks such as system failures, security breaches, and disruptions, adversely affecting business operations and end-user experiences. Traditionally, the manual assessment of technical debt has been a complex, expensive, and time-consuming process, consuming a significant portion of technology budgets and professional time.

Addressing these challenges, the disclosed system and model present a novel approach to assess, identify, and track technical debt, as well as adherence to well-architected framework principles, while adopting specific technology ecosystem guidelines. This approach, powered by artificial intelligence (AI), leverages the ability to access code repositories, application architecture diagrams, process flows, and various documents to identify gaps and document existing technical debt. By classifying technical debt into application and enterprise categories, the system offers a structured assessment that is advantageous for organizations aiming to optimize their technology landscape.

The general inventive scope of the claims encompasses a computing system and methods for evaluating and managing technical debt within a technology ecosystem. This system employs one or more processors and memories to collect data, determine coding signals, receive inputs from assessment and redesign systems, evaluate business capabilities, and generate a tech debt score. This score represents the technical debt of the technology ecosystem, providing a quantifiable measure of the issues that need addressing.

The aspects of the claims result in a practical application that effectively solves the prior art problems by improving suboptimal design, updating outdated code, revising inadequate infrastructure, patching security vulnerabilities, and enhancing data management efficiencies. The system's use of AI to automate the assessment and prediction of technical debt, coupled with its ability to incorporate human feedback for continuous learning and adjustment. This predictive capability allows organizations to proactively manage their technical debt, optimizing their technology investments and reducing the overall cost of the software development lifecycle. Additionally, the system's direct result of activities such as improving suboptimal design, updating outdated code, revising inadequate infrastructure, patching security vulnerabilities, and improving data management efficiencies that flow from the present techniques.

Another significant improvement is the optimization of network usage. The system's ability to remotely access and analyze data from code repositories and application architecture diagrams minimizes the need for extensive data transfers, thereby reducing network load. This efficient use of network resources is particularly beneficial for organizations with distributed teams and cloud-based infrastructures, ensuring that the assessment of technical debt does not disrupt other operations.

Furthermore, the system introduces improvements in memory usage further enhances its practical application, ensuring intelligent data processing and storage mechanisms. By selectively processing relevant data points and efficiently storing the results of the technical debt assessment, the system minimizes the memory footprint required for its operation. This efficient memory usage enables maintaining high performance and scalability without disrupting other operations. Through these improvements, the disclosed system and model offer a solution to the challenges of managing technical debt, enabling organizations to maintain a competitive edge in the rapidly changing technological landscape, especially in environments with limited computing resources.

### Exemplary Computing Environment

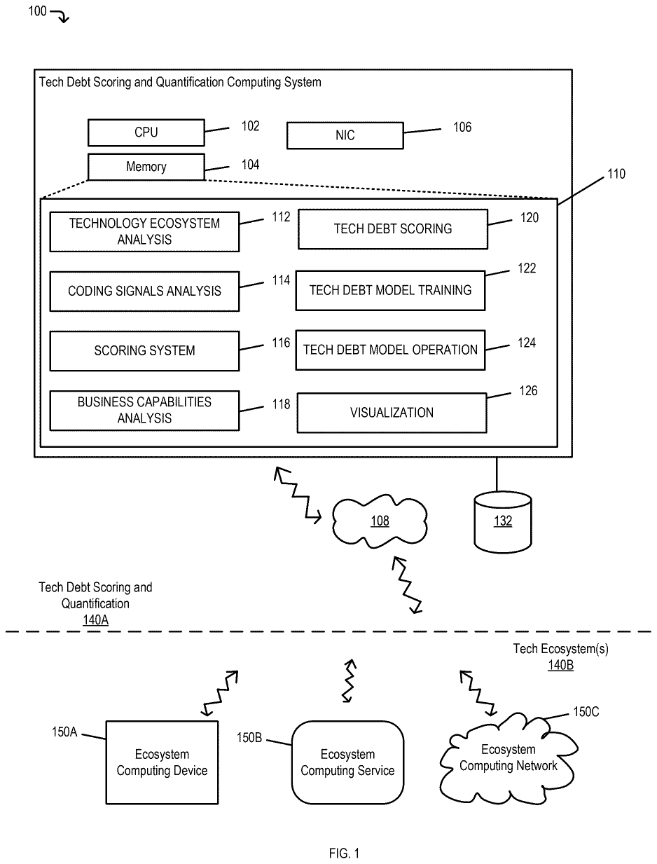

FIG. 1 depicts a technical debt and quantification computing environment 100 for assessing, identifying, and tracking technical debt within a technology ecosystem by analyzing code repositories, application architecture diagrams, and process flows against a well-architected framework and technology ecosystem guidelines, according to some aspects. The computing environment 100 includes a processor 102, a memory 104, and a network interface controller (NIC) 106. In some aspects, the computing environment 100 is designed to evaluate and manage aspects of a technology ecosystem and its associated technical debt, leveraging various sources of information and processing methods to provide understanding and mitigation of technical debt.

The processor 102 may include any number of processors and/or processor types, such as central processing units (CPUs), graphics processing units (GPUs), and others. Generally, the processor is configured to execute software instructions stored in the memory 104. The memory 104 may include volatile and/or non-volatile fixed and/or removable memory, such as read-only memory (ROM), random access memory (RAM), and others. The memory has stored thereon one or more sets of computer-executable instructions.

The memory 104 includes a plurality of modules 110, each including a respective set of computer-executable instructions. For example, a technology ecosystem analysis module 112 collects data about the entirety of the technological environment, including software and hardware platforms, tools, and processes in use. A coding signals analysis module 114 refers to specific signals or metrics derived from the coding practices, such as code complexity and coding standards adherence. A scoring system module 116 evaluates and combines different aspects of technology and business inputs to produce a composite score or assessment. A business capabilities analysis module 118 takes into account the functional abilities and processes of a business, and integrates how tech debt affects or is affected by business operations. A tech debt scoring module 120 assigns a score, rating, or evaluation regarding the technical debt of the system being assessed. The scoring system module 116 and tech debt scoring module 120 may receiving score information from one or more trained machine learning models operated by the environment 100, as discussed below.

Additionally, a tech debt model training module 122 is responsible for developing and refining the artificial intelligence models used in the assessment of technical debt. This module uses historical data, coding practices, and outcomes from previous technical debt assessments to train machine learning algorithms. The goal is to improve the accuracy and efficiency of the tech debt scoring process by enabling the system to learn from past assessments and adapt to new patterns in technical debt accumulation and resolution.

A tech debt model operation module 124 operates the trained AI models in real-time or near-real-time environments to assess current technical debt. This module applies the AI models to new data collected from the technology ecosystem, including code repositories, application architecture diagrams, and process flows. It uses the insights gained from the tech debt model training module 122 to evaluate the present state of technical debt, predict future states, and recommend actions for debt reduction or management. This operational module ensures that the system's technical debt assessments are up-to-date, relevant, and actionable, facilitating proactive management of technical debt in dynamic technology ecosystems.

The tech debt model training module 122 and tech debt model operation module 124 may respectively train and operate trained models (e.g., one or more neural networks and one or more generative AI (Gen AI) models) for quantifying and managing technical debt, wherein the models are trained using structured data and/or unstructured data from the organization's technology environment. The training process may be iterative and incorporate feedback mechanisms to refine the models over time. The tech debt model operation module 124 may operate models to generate scoring information for the scoring system module 116, in some aspects.

For example, the tech debt model training module 122 may collect a wide range of data from the organization's technology landscape, including code repositories, applications, architecture diagrams, tools, data products, and cyber controls & policies. This data may serve as the foundation for training the AI models. The collected data is then prepared for analysis, which may involve cleaning, normalization, and categorization to ensure it is in a suitable format for model training. The tech debt model training module 122 may generate a list of coding signals, which are specific characteristics or metrics related to technical debt. These signals include aspects like scalability, security, and compliance with standards. Additionally, the tech debt model training module 122 may assign weighted scores to these signals based on their importance or impact on technical debt. The process of defining these signals and their weights may be driven by expert knowledge and industry best practices. The tech debt model training module 122 may train the one or more neural network models the prepared data, with the goal of categorizing the various technology assets and identifying patterns related to technical debt. The neural network model learns from the coding signals and their weighted scores to understand how different factors contribute to technical debt. This training process involves feeding the model examples of technology assets along with their associated technical debt scores, allowing the model to learn and make predictions about unseen data. The tech debt model training module 122 may train one or more generative AI models to synthesize the categorized data into digital reports. This involves learning from examples of how data is summarized and reported in a meaningful way. The model may be trained on a dataset of existing reports or summaries created by experts, learning to generate similar outputs based on the input data it receives. The tech debt model training module 122 may incorporate human feedback. For example, the tech debt model training module 122 may use reinforcement learning with human feedback (RLHF), which allows the models to adjust and improve over time based on expert evaluations of their outputs. This feedback loop ensures that the models remain relevant and accurate as the organization's technology landscape and priorities evolve. In some aspects, the training process is not a one-time event but an ongoing cycle of improvement, in which as the models are used and generate outputs, the results are reviewed by experts who provide feedback. This feedback may then used by the tech debt model training module 122 to further refine the models, adjust the weighted scores of coding signals, and improve the accuracy of technical debt quantification and reporting. The tech debt model operation module 124 may supervise and orchestrate the RLFH process, in some aspects.

For the development, training, and operation of the tech debt model training module 122, a suite of software tools and technologies is essential to handle the complexities involved in assessing technical debt across a technology ecosystem. The foundation of this technical stack involves machine learning and data science libraries. In some aspects, open source libraries such as TensorFlow, PyTorch, Scikit-learn, and Pandas in Python may be used to accelerate development and management of software. These libraries may provide routines for data manipulation, statistical modeling, and constructing neural networks. To manage the potentially large volumes of data, big data processing frameworks like Apache Spark or Hadoop may be employed for efficient data processing and analysis. Cloud embodiments may include the use of AI and machine learning platforms such as Google AI Platform, Azure Machine Learning, or AWS SageMaker.

The tech debt model training module 122 may train one or more language model (LM). In some aspects, the tech debt model training module 122 may pre-train a model and/or fine-tune a model locally. In some aspects, such pre-training and/or fine-tuning may be performed using a cloud platform/API such as Large Language Models (LLMs) fine-tuning of a commercially-available model such as OpenAI's GPT (Generative Pre-trained Transformer). LMs can assist in generating code, providing documentation, and even in some aspects of model training and data analysis by automating the generation of code snippets, interpreting complex data sets, and summarizing technical documents. The integration of LM tools into the development process can enhance productivity, improve code quality, and accelerate the development cycle of AI models for technical debt assessment. This technical stack, enriched with LM capabilities, represents a foundation for effectively managing the challenges associated with assessing and addressing technical debt within a technology ecosystem.

The NIC 106 enables network connectivity, and may include a controller chip that acts as the central processing unit, managing data transmission and reception, handling error checking, and executing network protocol operations. The NIC may also include a bus interface that connects the NIC to the system 200, facilitating communication between the network 108 and the system 100. The NIC 106 may include includes Ethernet ports that provide the physical connection points for network cables and may include wireless communication components, such as antennas and transceivers for Wi-Fi connectivity. The NIC 106 may include additional functionality, in some aspects.

The electronic network 108 may connect the system 100 and facilitates its interaction with external data sources and users. The network 108 may include both physical and virtual components that together enable the transmission of data across the system 100. The physical components of the electronic network 108 may include one or more servers that store and process data, routers and switches that direct data traffic, and cabling and/or wireless technology infrastructure that links these devices. The virtual components may include software such as network operating systems, network management tools, and communication protocols that ensure data is transmitted securely and arrives at its intended destination within the system 100. The technology ecosystem analysis 112 may access the network 108 to collect data from a wide range of sources, including internal systems, databases, and online resources.

The electronic network 108 enables user interaction with system 100 through various interfaces, such as web portals or applications, allowing them to input data, configure settings, and view outputs like reports, dashboards, and interactive chatbots via one or more APIs (not depicted). The network 108 ensures that interactions between users and the system are smooth and responsive, enhancing the user experience.

For example, the system 100 may be communicatively coupled to and/or include within its memory 104 an electronic database 132. The electronic database 132 may be designed to store and manage the data collected and generated by the system 100. The database 132 may consist of structured data, such as process information, technology information, governance information, and data from the tech ecosystem, as well as unstructured data, including industry reports, news articles, and technical documentation. The electronic database 132 may be optimized for rapid data retrieval and analysis, supporting the system's need to access historical and current data efficiently for the purpose of identifying, assessing, and mitigating technical debt. The design, structure and implementation of the electronic database 132 may be aligned with the requirements of the technical debt system.

For example, to implement the electronic database 132 within system 100, one or more database technologies may be utilized, such as a relational database management system (RDBMS) (e.g., MySQL, PostgreSQL, or Oracle Database); a NoSQL databases (e.g., MongoDB, Cassandra, or Couchbase) a graph database, an in-memory database, a time-series database, a cloud-based database, etc.

The computing environment of FIG. 1 may be logically divided according to a tech debt assessment environment 140A, and one or more tech ecosystems 140B, in some aspects. The tech debt assessment environment 140A may include the system 100 and its components. For example, the tech ecosystems 140B may include one or more components that are evaluated for technical debt levels. The one or more tech ecosystems 140B may include one or more ecosystem computing device 150A, one or more ecosystem computing services 150B, and/or one or more ecosystem computing networks 150C. Of course, depending upon the environment in which the system 100 is deployed, the one or more tech ecosystems 140B may include more or fewer (or different) components 150. For example, the components 150 may include various interconnected components that work together, such as operating systems, applications, and development tools that enable devices to perform tasks and provide functionality to users; network infrastructure including local area networks (LAN), wide area networks (WAN), the internet, and wireless networks; data that is processed, stored, and transmitted by the computing ecosystem, including databases, data warehouses, and big data platforms; security components such as encryption software/devices, firewalls, and antivirus software; cloud/remote servers and services that provide scalable computing resources, storage, and applications over the internet; middleware such as APIs and message brokers/queues; user interfaces including graphical user interfaces (GUIs), command-line interfaces (CLIs), and voice interfaces; hardware and solutions for saving data, such as hard drives, solid-state drives (SSDs), network-attached storage (NAS), and cloud storage; integration services; support/maintenance services including technical support, software updates, and hardware maintenance; and standards and protocols. Any of the foregoing devices, services, networks, etc. may contribute to technical debt, and may be modified to mitigate that debt using the present techniques.

One or more components of the computing environment of FIG. 1 may be implemented as cloud-based services. For example, the electronic database 132 may be hosted on a cloud platform such as Amazon Web Services (AWS), Google Cloud Platform (GCP), or Microsoft Azure, leveraging scalable storage solutions and managed database services like Amazon RDS or Google Cloud SQL. This cloud-based implementation allows for dynamic scaling to accommodate varying loads and data volumes, ensuring that the system can efficiently handle the extensive data analysis required for evaluating and managing technological debt. Additionally, merely for example, the tech debt model training module 122 and the tech debt model operation module 124 may utilize cloud-based machine learning and AI services, such as AWS SageMaker or Google AI Platform, to train and deploy sophisticated models for identifying and mitigating technical debt. This cloud-based approach provides the flexibility and computational power needed to process large datasets and apply complex algorithms, enhancing the system's ability to deliver real-time insights and recommendations. It should be appreciated that the system 100 could utilize a public cloud, such as AWS, GCP, or Azure, to leverage their infrastructure and services for scalability and flexibility. Alternatively, a private cloud may be employed, offering more control over the environment and potentially enhanced security for sensitive data related to technological debt. A hybrid cloud approach may also be adopted, combining the benefits of both public and private clouds by keeping certain critical operations and data on-premises or in a private cloud for security and compliance reasons, while utilizing the public cloud for scalable computing resources and advanced services. This hybrid model allows for a balanced approach, optimizing the system's performance and security based on the specific needs of evaluating and managing technological debt.

In operation, the computing environment 100 serves as a system that assesses, identifies, and tracks technical debt within a technology ecosystem. It analyzes code repositories, application architecture diagrams, and process flows against a well-architected framework and technology ecosystem guidelines. The system uses artificial intelligence to forecast and predict the desired technical debt score and timeline based on the assessment. It integrates human feedback for continuous learning and adjustment of the technical debt assessment process. The system scans the technology ecosystem using various sources and leverages neural networks for classification of technical debt. It analyzes coding signals that define the technical debt score, including scalability, security, and other factors. The system incorporates domain information, regulatory information, and strategic insights to understand the business impact of technical debt. It classifies technical debt scores by application and business function, providing business insights and actions for business units. The computing environment 100 integrates various information sources and processing methods to evaluate the existing technological framework and manage technical debt, embodying a collaborative framework that brings together multiple aspects of a technology ecosystem.

Generally, the computing environment 100 functions as a system designed to assess, identify, and manage technical debt within a technology ecosystem. At its core, the system leverages a series of specialized modules, each contributing to the overall functionality and efficiency of the technical debt assessment process. The technology ecosystem analysis module 112 initiates the process by collecting data across the entire technological environment, including software and hardware platforms, tools, and processes in use. This foundational data collection step ensures a holistic view of the technology landscape is considered in the assessment. Following data collection, the coding signals analysis module 114 analyzes specific signals or metrics derived from coding practices, such as code complexity and coding standards adherence. This analysis enables identifying areas where technical debt may be accumulating due to suboptimal coding practices. Concurrently, the scoring system module 116 evaluates and combines different aspects of technology and business inputs to produce a composite score or assessment of the technical debt. This scoring system module 116 enables quantifying the level of technical debt, making it easier to prioritize remediation efforts. The business capabilities analysis module 118 further enriches the assessment by considering the functional abilities and processes of a business, integrating insights on how technical debt affects or is influenced by business operations. This module ensures that the technical debt assessment is aligned with business priorities and objectives. Additionally, the tech debt scoring module 120 assigns a score, rating, or evaluation regarding the technical debt of the system being assessed, providing a clear and actionable metric for stakeholders. The tech debt model training module 122 plays a pivotal role in developing and refining the artificial intelligence models used in the assessment of technical debt. By using historical data, coding practices, and outcomes from previous technical debt assessments, this module trains machine learning algorithms to improve the accuracy and efficiency of the tech debt scoring process. The insights gained from this training enable the system to learn from past assessments and adapt to new patterns in technical debt accumulation and resolution. Finally, the tech debt model operation module 124 applies the trained AI models to new data collected from the technology ecosystem, including code repositories, application architecture diagrams, and process flows. This module ensures that the system's technical debt assessments are up-to-date, relevant, and actionable, facilitating proactive management of technical debt in dynamic technology ecosystems.

The tech debt model training module 122 is designed to develop and refine the artificial intelligence models used in the assessment of technical debt. This module utilizes historical data, coding practices, and outcomes from previous technical debt assessments to train machine learning algorithms. The objective is to enhance the accuracy and efficiency of the tech debt scoring process by enabling the system to learn from past assessments and adapt to new patterns in technical debt accumulation and resolution. The training process for module 122 may involve collecting a comprehensive set of data points from various sources within the technology ecosystem, including code repositories, application architecture diagrams, and process flows. This data is then analyzed to identify coding signals, which are specific metrics derived from coding practices such as code complexity and coding standards adherence. Additionally, the module considers inputs from both a technical debt assessment system and an organizational redesign system to inform the technology ecosystem assessment. The training process may include the development of a scoring system that evaluates the collected data, derived coding signals, inputs, and business capabilities. This scoring system generates a tech debt score, which quantitatively represents the technical debt of the technology ecosystem. The tech debt score is determined based on a range of factors, including scalability, security, and other elements that define the technical debt score. Further, the training module may incorporate weighted scores for different signals, prioritizing certain aspects over others based on their impact on the technology ecosystem. For example, signals related to cybersecurity vulnerabilities may carry a higher weight compared to other signals. This weighted scoring approach allows for a more nuanced and accurate assessment of technical debt. The training process may involve forecasting and predicting the desired technical debt score and timeline based on the initial evaluation, using artificial intelligence. This predictive capability enables organizations to proactively manage their technical debt, optimizing technology investments and reducing the overall cost of the software development lifecycle.

Further operation of the computing environment 100 is included in the following description of motivating use cases. It should be appreciated that other use cases are contemplated.

### Exemplary Use Cases

For example, in the use case of Legacy System Modernization, each module within the computing environment 100 in identifying, quantifying, and prioritizing the modernization of a legacy system that is costly to maintain and hinders organizational agility. The technology ecosystem analysis module 112 initiates the process by collecting comprehensive data on the system's architecture. This module lays the groundwork for understanding the scope and scale of the technical debt by providing a detailed overview of the legacy system's current state, including software and hardware platforms, tools, and processes in use. Following this, the coding signals analysis module 114 steps in to evaluate the codebase for complexity and adherence to coding standards. This module analyzes specific signals or metrics derived from coding practices, identifying areas where the codebase deviates from best practices or exhibits high complexity, which are indicative of technical debt. The insights generated by module 114 are essential for pinpointing the specific aspects of the codebase that contribute to the system's maintenance challenges and lack of agility. Once the data collection and analysis phases are complete, the scoring system module 116 quantifies the technical debt identified by modules 112 and 114. This module evaluates and combines different aspects of technology and business inputs to produce a composite score or assessment of the technical debt. The quantification of technical debt by module 116 highlights critical areas that need modernization and provides a tangible metric that can be used to prioritize remediation efforts. Finally, the business capabilities analysis module 118 assesses the impact of the identified technical debt on business capabilities. This module takes into account the functional abilities and processes of the business, integrating insights on how technical debt affects or is influenced by business operations. The analysis performed by module 118 ensures that modernization efforts are aligned with business priorities and objectives, enabling the organization to make informed decisions about which aspects of the legacy system to modernize first.

In another use case, of Security Vulnerability Identification, the system leverages its modules to proactively identify and address security vulnerabilities within an application, thereby minimizing the risk of system failures or data breaches. Initially, the coding signals analysis module 114 scans the application's codebase for known security vulnerabilities. This module utilizes its capabilities to analyze specific metrics and signals derived from coding practices, focusing on patterns and constructs that are commonly associated with security weaknesses. By identifying these vulnerabilities early, module 114 enables the organization to pinpoint areas of the codebase that pose a security risk. Following the identification of potential vulnerabilities by module 114, the tech debt model operation module 124 takes a forward-looking approach to security. Module 124 utilizes AI models that have been trained to recognize patterns indicative of security vulnerabilities, as developed by the tech debt model training module 122 (not directly involved in this use case but critical for preparing module 124). These AI models apply their predictive capabilities to the current coding practices observed in the application, forecasting potential future vulnerabilities that might not yet be known or exploited. This predictive analysis by module 124 enables allowing organizations to not only address current security concerns but also anticipate and mitigate future risks. By combining the immediate identification of known vulnerabilities with predictive analysis for future risks, the system advantageously empowers organizations to take a proactive stance on security. This approach ensures that vulnerabilities can be addressed before they are exploited, significantly reducing the risk to the business and safeguarding against potential disruptions or data breaches. Through the roles of modules 114 and 124, the system facilitates a robust security posture that aligns with the organization's broader objectives of maintaining secure, reliable, and resilient technology ecosystems.

In a further use case, of Integration Challenges with New Technologies, the organization faces the task of integrating new technologies into its existing technology ecosystem, a process complicated by the presence of technical debt in current systems. To navigate these challenges, specific modules within the computing environment 100 are deployed to assess compatibility, identify gaps, and quantify technical debt, thereby guiding strategic decisions on system upgrades or replacements. In some aspects, the technology ecosystem analysis module 112 initiates the process by conducting an assessment of the compatibility between the current systems and the new technologies intended for integration. The technology ecosystem analysis module 112 may systematically collect and analyze data concerning the organization's entire technological environment, including software and hardware platforms, tools, and processes in use. By identifying gaps and documenting existing technical debt, technology ecosystem analysis module 112 advantageously provides a clear picture of the hurdles that may impede successful integration, such as outdated components or systems that no longer meet the organization's evolving technological needs. Following the assessment conducted by module 112, the scoring system module 116 may quantify the technical debt specifically related to the integration challenges identified. This quantification enables translation of the qualitative analysis of technical debt into a tangible metric that can be used to prioritize actions. The scoring system module 116 evaluates and combines various aspects of technology and business inputs, including the compatibility issues and gaps identified by module 112, to produce a composite score or assessment of the technical debt. This scoring process highlights the most critical areas where technical debt impedes integration, enabling the organization to prioritize which systems require immediate attention for upgrade or replacement.

In yet another use case, of Optimizing Development Processes, the system is employed to enhance the efficiency of development teams by pinpointing and addressing areas where technical debt impedes productivity. This optimization process involves coordination among the coding signals analysis module 114, the tech debt model training module 122, and the tech debt model operation module 124, which respectively identify, learn from, and mitigate technical debt. Specifically, the coding signals analysis module 114 initiates the optimization process by conducting a detailed analysis of coding practices across various development teams. This module's primary function is to sift through the codebase, identifying specific patterns and practices that historically lead to the accumulation of technical debt, such as complex code structures, lack of adherence to coding standards, or repeated use of deprecated libraries. By pinpointing these detrimental patterns, module 114 lays the groundwork for targeted interventions to improve coding practices and, consequently, functionality of the computing environment 100. For example, the coding signals analysis module 114 contributes to hardware efficiency by identifying inefficient coding practices that can lead to excessive CPU usage, memory leaks, or prolonged disk I/O operations. By pinpointing these inefficiencies, the module aids in the optimization of code that, when executed, places less strain on the CPU, uses memory more efficiently, and minimizes unnecessary disk I/O operations. This optimization directly improves the performance of computer hardware by ensuring that applications run more smoothly, respond faster, and consume fewer resources, thereby extending the hardware's operational lifespan and reducing the need for frequent upgrades. It should be appreciated that other forms of technical debt identification and reduction may lead to other positive effects that touch on computer hardware. Following the identification of problematic coding patterns by module 114, the tech debt model training module 122 may enhance the system's predictive capabilities by module 114 to train AI models, equipping them with the ability to recognize and predict the occurrence of similar patterns that contribute to technical debt. This training process enables the AI models to learn from past and current coding practices, improving their accuracy and effectiveness in identifying technical debt. Once trained, the AI models may be deployed by the tech debt model operation module 124 to provide real-time feedback to developers. Module 124 may operate these models in the environment 140A and/or the ecosystem 140B, applying the trained models to new and existing code to detect patterns indicative of technical debt. When such patterns are identified, module 124 delivers actionable feedback to developers, advising on best practices and suggesting improvements to coding practices that can minimize the future accumulation of technical debt.

In the use case of Strategic Decision Making for Business Recovery Preparedness, the system is utilized to ensure that an organization is adequately prepared for disaster recovery (DR) by assessing and addressing technical debt that could impede recovery efforts. This process involves the business capabilities analysis module 118 and the tech debt scoring module 120, each contributing to the organization's strategic planning and prioritization for DR preparedness. The business capabilities analysis module 118 may evaluate how technical debt within the organization's systems and processes could affect its ability to recover from a disaster efficiently. This evaluation involves analyzing the functional abilities and processes of the business, with a specific focus on areas where technical debt-such as outdated systems, suboptimal design, or inadequate infrastructure-could hinder DR efforts. For example, module 118 might identify a critical financial system that, due to legacy code and outdated infrastructure, would not be able to be quickly restored or migrated in the event of a disaster. By assessing the impact of technical debt on business operations, module 118 provides essential insights that inform the organization's DR strategy, highlighting areas where improvements are urgently needed to ensure business continuity. Following the assessment conducted by module 118, the tech debt scoring module 120 may assign a score to each system within the organization based on its DR preparedness. This scoring process quantifies the level of technical debt related to DR for each system, taking into account factors such as the system's criticality to business operations, the complexity of recovery processes, and the potential impact of downtime. By assigning scores, module 120 enables the organization to objectively compare the DR preparedness of different systems, identifying those that pose the greatest risk to business recovery efforts. For instance, a high score assigned to a customer service platform might indicate significant technical debt that could delay recovery times, necessitating prioritized remediation. Through the coordinated efforts of modules 118 and 120, the organization gains a clear understanding of the technical debt impacting its DR preparedness. This strategic insight allows for informed decision-making, enabling the organization to allocate resources effectively and prioritize improvements in systems that are critical to business recovery. By assessing the impact of technical debt on DR capabilities and quantifying this impact through scoring, the system supports the organization in enhancing its resilience and preparedness for potential disasters, ensuring that it can recover with minimal disruption to operations.

### Exemplary Computer-Implemented Methods

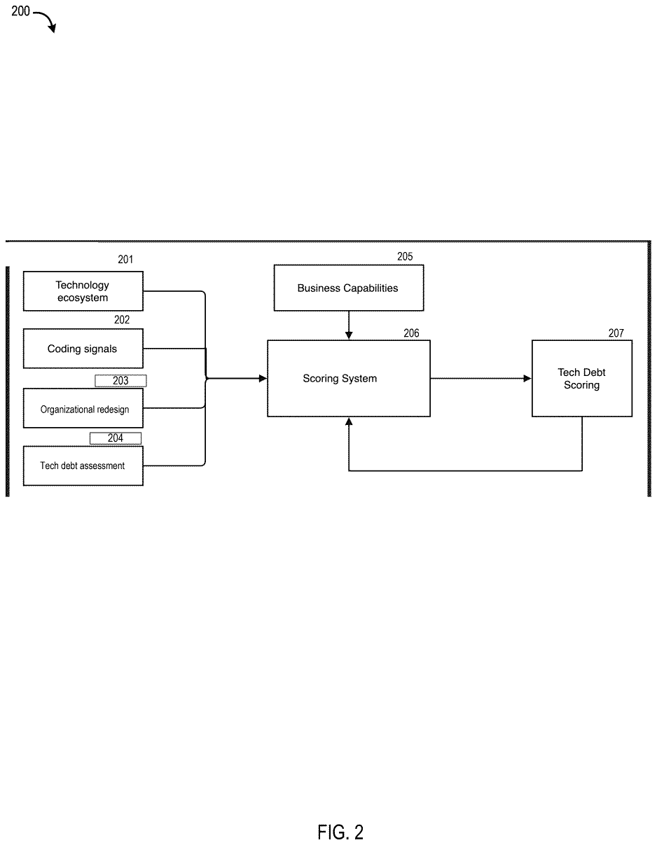

FIG. 2 depicts a computer-implemented method 200 for evaluating and managing technical debt within a technology ecosystem. This method is designed to assess the technical debt of various components within a technology ecosystem, including software and hardware platforms, tools, and processes, and to generate a tech debt score that represents the overall technical debt of the ecosystem. The method 200 may be performed by the components of FIG. 1 (e.g., the environment 100) as discussed above.

The method 200 may include collecting data from a technology ecosystem, including software and hardware platforms, tools, and processes (block 201). This step involves gathering comprehensive information about the technology infrastructure and operations of an organization to understand the current state of its technology ecosystem.

The method 200 may include determining coding signals from coding practices, including code complexity and coding standards adherence (block 202). This involves analyzing the coding practices within the organization to identify patterns and signals that may indicate potential technical debt, such as high complexity codes or deviations from established coding standards.

The method 200 may include receiving inputs from one or both of a technical debt assessment system and an organizational redesign system, to inform a technology ecosystem assessment (blocks 203, 204). This step allows for the integration of insights from specialized systems designed to assess technical debt and suggest organizational redesigns, providing a more nuanced understanding of the technology ecosystem's state.

At blocks 203 and 204, the system may analyze specific tech environment. At block 203, organizational redesign information is received into the system method 200. Block 204 enables tech debt assessment. The method 200 may receive organizational redesign information using methods and systems detailed in U.S. patent application Ser. No. 18/885469; entitled “System, Method and Computer-Readable Medium for Organizational Redesign Through Analysis and Phased Implementation Based on User Input and Current Models ”, filed on Sep. 13, 2024 and hereby incorporated by reference in its entirety. In some aspects, the system 200 may receive tech debt assessment information at block 204 using the methods and systems of U.S. patent application Ser. No. 18/889583; entitled “ANALYSIS AND CLASSIFICATION METHODS AND SYSTEMS FOR ASSESSING, IDENTIFYING, AND TRACKING TECHNICAL DEBT IN ORGANIZATIONS”, filed on Sep. 19, 2024 and hereby incorporated by reference in its entirety.

The method 200 may include determining business capabilities including functional abilities and processes of a business (block 205). This involves assessing the business's operational capabilities and processes to understand how they are supported by the technology ecosystem and how technical debt may be impacting business performance.

The method 200 may include evaluating the collected data, derived coding signals, inputs, and business capabilities using a scoring system (block 206). This step involves synthesizing the information gathered in the previous steps to evaluate the overall technical debt of the technology ecosystem using a predefined scoring system.

The method 200 may include generating a tech debt score based on the evaluation (block 207). This final step produces a tech debt score that quantifies the technical debt of the technology ecosystem, providing a metric that can be used to guide decision-making and prioritization of technical debt reduction efforts.

The method 200 may include analyzing application architecture diagrams and process flows against a well-architected framework and technology ecosystem guidelines. This involves a detailed review of application architectures and process flows to identify misalignments with best practices and guidelines, which can contribute to technical debt. The method 200 may include determining coding signals further includes analysis of scalability, security, and other factors defining the technical debt score. This expands the analysis of coding practices to include considerations of scalability and security, among other factors, recognizing that these aspects can significantly contribute to technical debt. The method 200 may include using artificial intelligence to forecast and predict the desired technical debt score and timeline based on the initial evaluation. This involves leveraging AI technologies to project future states of technical debt and to estimate timelines for achieving desired technical debt levels, facilitating strategic planning and prioritization. The method 200 may include integrating human feedback for continuous learning and adjustment of the technical debt assessment process. This step emphasizes the importance of incorporating feedback from stakeholders and users to refine and improve the technical debt assessment process over time, ensuring it remains relevant and effective. The method 200 may include incorporating domain information, regulatory information, and strategic insights to understand the business impact of technical debt. This involves considering the specific context of the business, including its industry domain, regulatory environment, and strategic objectives, to better understand how technical debt impacts its operations and performance. The method 200 may include classifying technical debt scores by application and business function, providing business insights and actions for business units. This step involves breaking down the overall tech debt score into more granular assessments for specific applications and business functions, enabling targeted actions and insights for different parts of the organization.

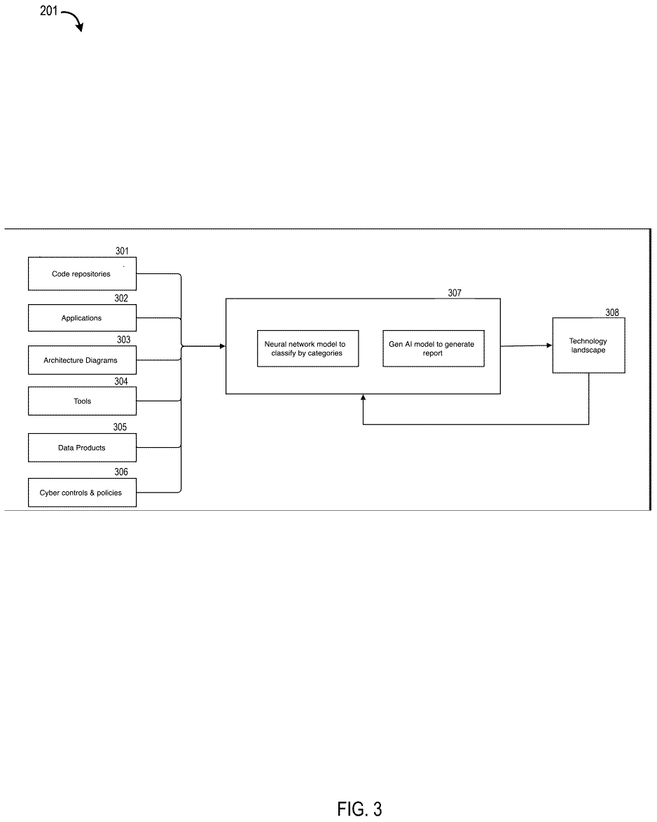

FIG. 3 illustrates a flow diagram representing a computer-implemented method 201 for generating a technology landscape overview within a technology environment, according to some aspects. This method is designed to provide an organized representation of the various technological assets and policies, such as code repositories, applications, architecture diagrams, and data products, and utilizes machine learning models to categorize these assets and ultimately generate a comprehensive report on the technology landscape. The method 201 may be performed by components that may encompass various data sources and intelligent systems. It should be appreciated that the method 201 may be performed as a routine separately of the method 200 (e.g., by the processor 102 of FIG. 1), in some aspects. The method 201 may include collecting data from a set of technology-related sources within an organization (block 301, 302, 303, 304, 305, 306). This step involves amassing data from code repositories (301), applications (302), architecture diagrams (303), tools (304), data products (305), and cyber controls & policies (306), which together represent a significant portion of an organization's technology infrastructure and governance framework. The method 201 may include applying a neural network model to classify the gathered data into categories (block 307), as discussed with respect to FIG. 1, above. This classification process may utilize a neural network to automatically sort and categorize the various data elements based on their characteristics and relevance. This step streamlines the process of organizing the data for further analysis. The method 201 may include generating a report leveraging another artificial intelligence model (block 307). This involves feeding the categorized data into a generative AI model that processes and synthesizes the information to create a detailed report. This report serves as the output of the process and reflects the refined and categorized technology landscape. The method 201 may include producing the technology landscape overview (block 308). This final step completes the flow diagram by utilizing the generated report to present a clear and informative overview of the technology landscape. The technology landscape overview thus derived from the flow diagram can serve as a tool for decision-making, strategic planning, and assessment of an organization's technological position and infrastructure.

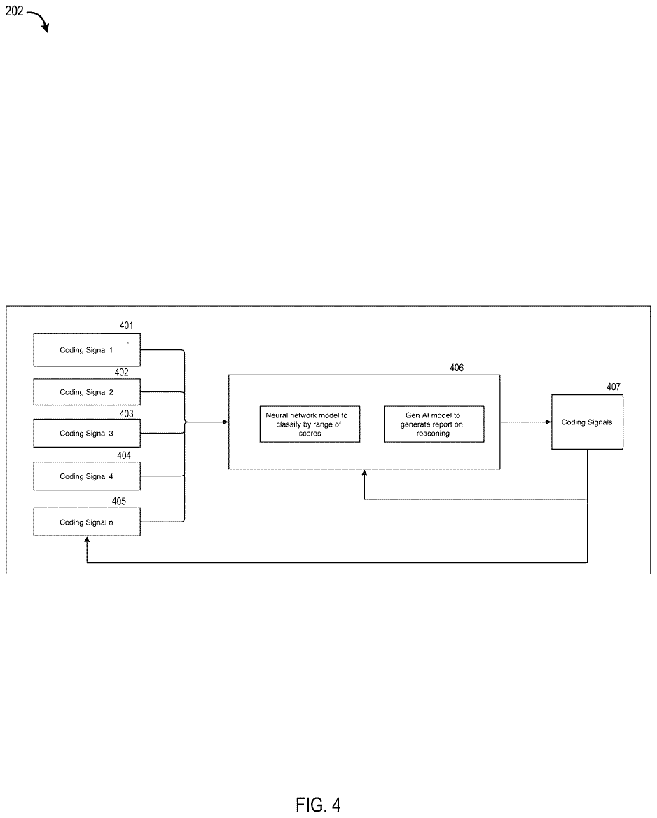

FIG. 4 depicts a flow diagram that outlines a method for processing coding signals through a neural network and generating a report based on the classification of those signals, according to some aspects. This method may correspond to block 202 in the example provided, where each step of the method could be performed within a particular technology ecosystem or environment as discussed above. The method may begin with multiple coding signals being identified, designated by blocks 401, 402, 403, 404, and 405, representing “Coding Signal 1,” “Coding Signal 2,” “Coding Signal 3,” “Coding Signal 4,” up to “Coding Signal n,” suggesting a flexible number of inputs to the process. These coding signals are then collectively input into a neural network model designated by block 406, which is responsible for classifying by range of scores. This step involves the neural network processing the coding signals to categorize them according to assigned score ranges indicative of various criteria such as coding quality, complexity, or adherence to best practices. Subsequently, the output from the neural network model is directed to another model represented by block 407 (e.g., a Gen AI model to generate report on reasoning). In this step, a generative AI model takes the classification data from the neural network and compiles a report that includes explanations or reasoning behind the assigned classification scores. Finally, the flow loops back indicating that the output coding signals, which have presumably been analyzed and documented, can be reintegrated into the system or used as feedback for further processing, denoted by the arrow returning to the collective inputs (blocks 401-405).

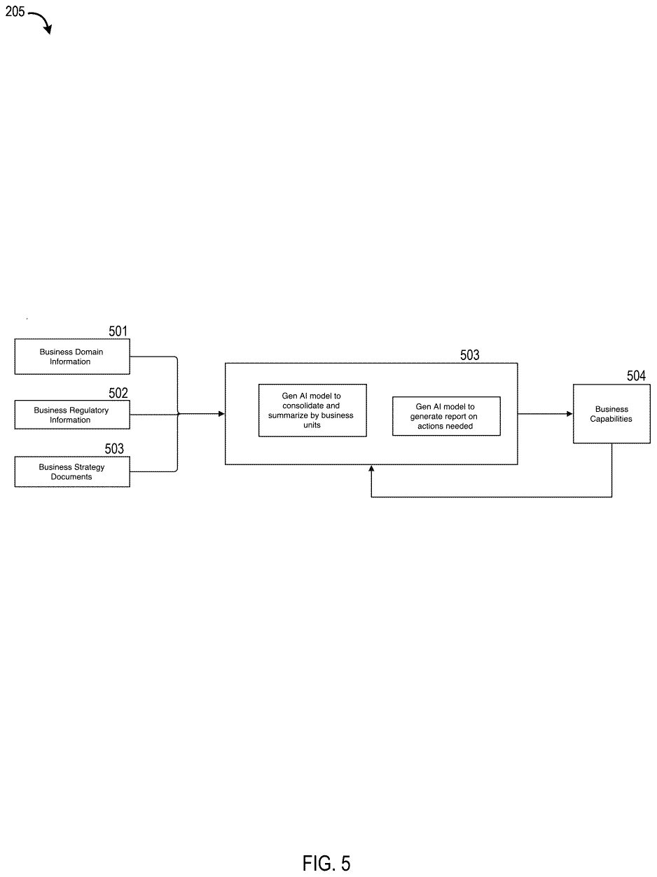

FIG. 5 depicts a flow diagram illustrating a method 205 for generating artificial intelligence (AI) models based on various business-related inputs, according to some aspects. The method 205 correlates to method 205 described in FIG. 2, which details how business capabilities are determined. The method 205 may include receiving Business Domain Information (block 501). This step involves collecting information specific to the business domain in which the organization operates. The method 205 may also include receiving Business Regulatory Information (block 502), which involves collecting data about regulations that apply to the business, ensuring any models or strategies developed are compliant with current laws and industry standards. In addition, the method 205 may involve analyzing Business Strategy Documents (block 503). This step consists of reviewing strategic documentation to align the AI models with the goals and directions of the business. The method 205 may also include generating an AI model to consolidate and summarize business units (block 503), which may include creation of AI algorithms or systems aimed at aggregating and synthesizing information across different units of the business for better governance and insight. Furthermore, the method 205 can comprise generating an AI model to generate a report on actions needed (block 503). This involves using AI to interpret the consolidated data and produce actionable insights, possibly identifying areas that require intervention or improvement. Ultimately, the output of this method is to assist in identifying or enhancing Business Capabilities (block 504), signifying the connection between the generated AI models and the operational abilities and processes of the business. This may result in bolstering the company's capabilities through informed decision-making supported by AI-driven analyses.

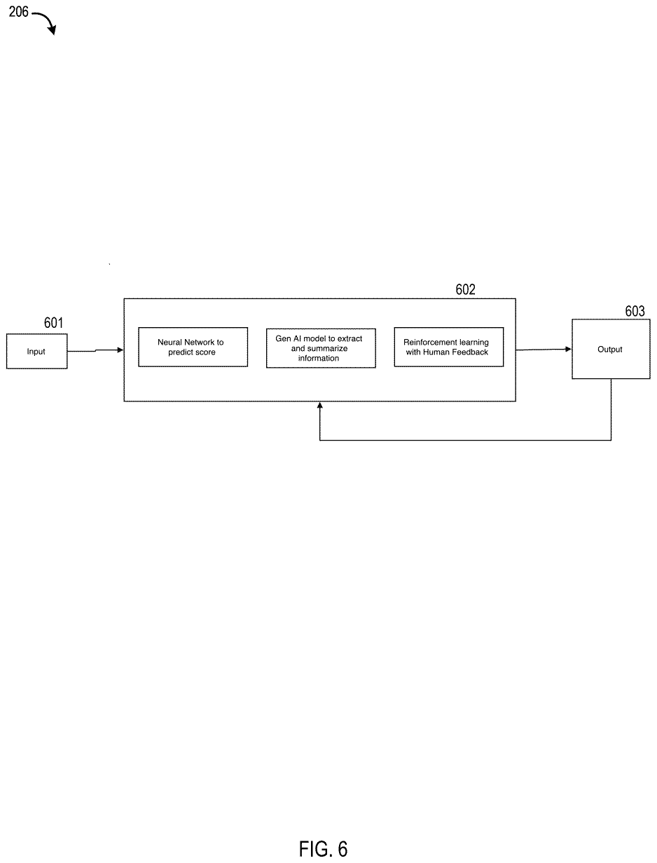

FIG. 6 illustrates a flow diagram for a method 206, which is designed for processing an input and generating an output using artificial intelligence and machine learning techniques, according to some aspects. The method 206 may be implemented by the components similar to those discussed in connection with method 200 of FIG. 2 in the provided example. The method 206 includes an initial step of receiving input (block 601), which corresponds to the collective steps of gathering data, assessing coding signals, receiving inputs from various systems, and determining business capabilities (blocks 201-205 of FIG. 2) mentioned in the example. The input at block 601 is then processed by a scoring system (block 602) using a Neural Network to predict a score, followed by the application of a Gen AI model to extract and summarize information. After processing the input, the method 206 advances to incorporate Reinforcement learning with Human Feedback, which aligns with the concept of integrating human feedback for continuous learning and adjustment, as described in the flow of the example method 200. The final step in method 206 is generating the output (block 603), which corresponds to the generation of the tech debt score (block 207 of FIG. 2) in the example. This output is the result of evaluating and synthesizing the information processed in the preceding steps within the flow diagram.

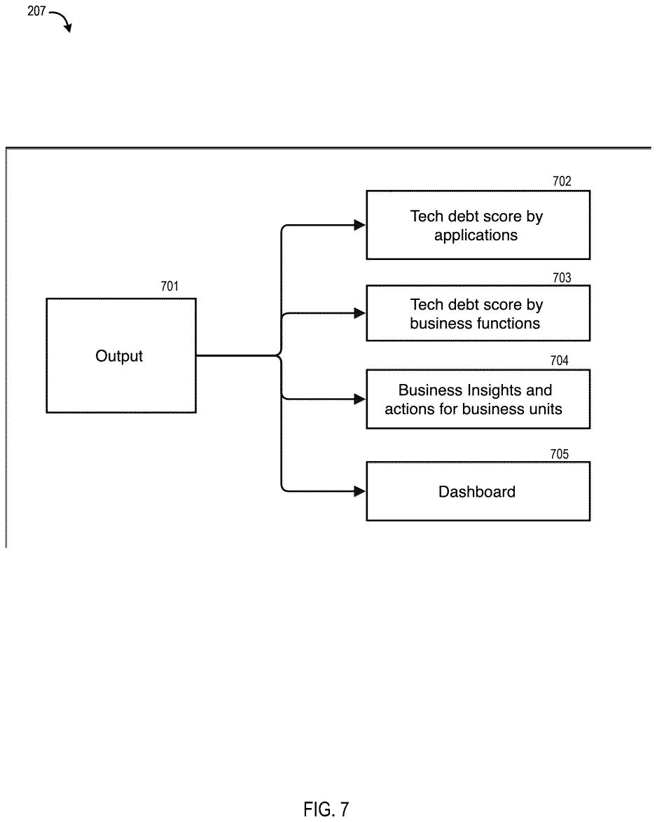

FIG. 7 depicts an output system 207 for evaluating and managing technical debt within a technological or business environment, according to some aspects. The system represented in the diagram is designed to process various measurements and assessments related to technical debt and provide actionable insights for applications, business functions, and business units through a dashboard interface. The output system 207 includes an Output block 701, which serves as the initial step in the processing and delivery of data. The diagram suggests that the Output block 701 is connected to multiple subsequent outputs, representing different aspects of technical debt measurement and business insight generation that stem from the initial output. Block 702 corresponds to ‘Tech debt score by applications’, which indicates that the system is configured to calculate and assign a technical debt score for individual applications within a technology ecosystem or business infrastructure. This demonstrates a granular level of analysis regarding the quality, maintainability, and potential liabilities of the software applications used by the business. Block 703 represents ‘Tech debt score by business functions’, suggesting that the system further refines technical debt assessment to business functions, thereby enabling an understanding of how technical debt affects specific operational areas within the organization. Block 704, designated as ‘Business Insights and actions for business units’, indicates that the system synthesizes technical debt data and other measurements to provide strategic insights and recommend actions tailored for individual business units. This function aims to facilitate decision-making and prioritization of efforts to address technical debt. Lastly, block 705 corresponds to ‘Dashboard’, implying that the system includes a dashboard interface for visualizing and interacting with the technical debt scores, business insights, and recommended actions. A dashboard typically provides stakeholders with an accessible and user-friendly means to assess the state of technical debt and to monitor progress toward addressing it.

### Exemplary Language Model Architecture

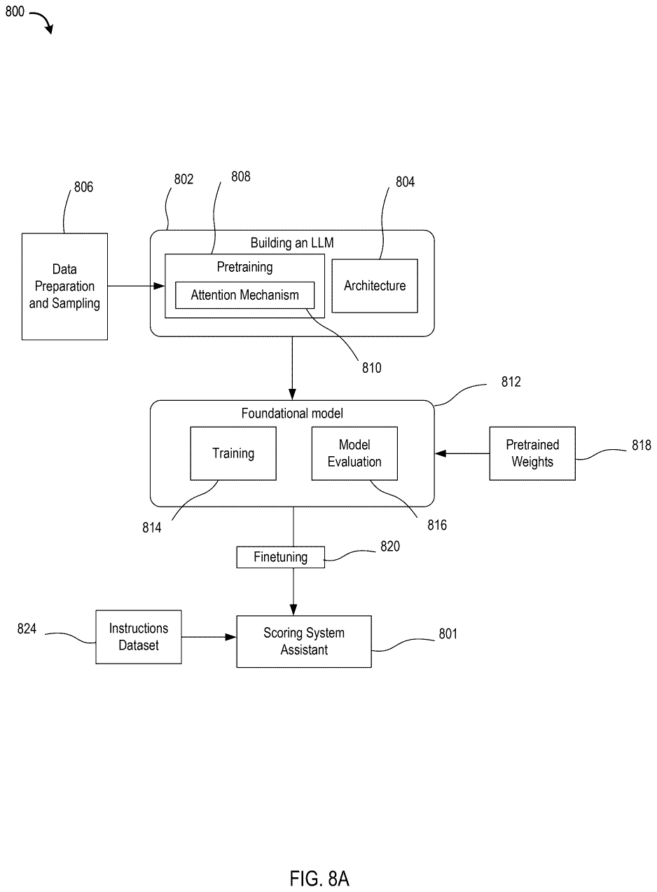

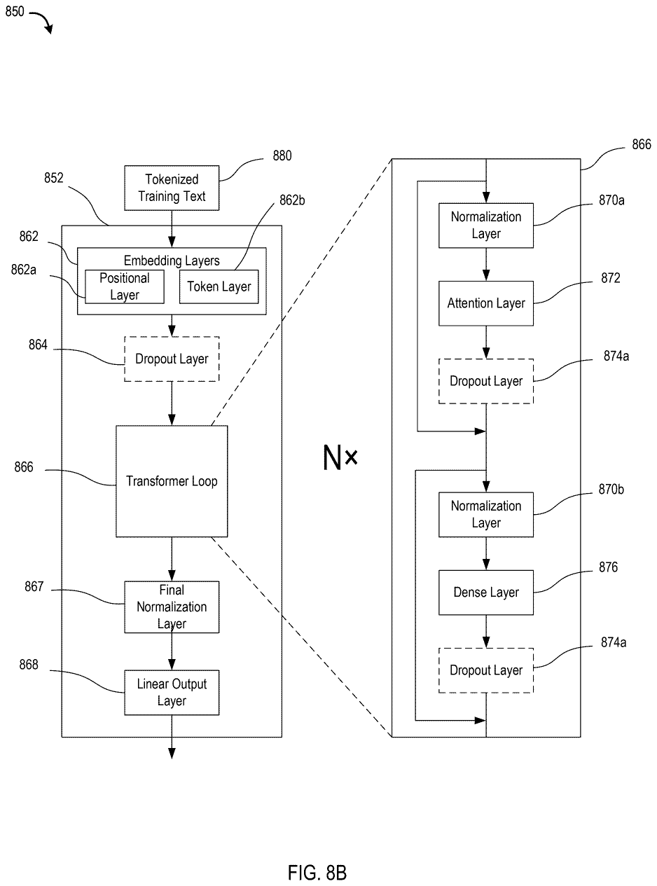

FIG. 8A depicts a block-flow diagram outlining a method 800 for building and applying an artificial intelligence model, specifically a language learning model (LLM), according to some aspects. The method 800 may include the creation and/or utilization of an LLM to develop a scoring system assistant. The method 800 begins with data preparation and sampling, which includes processing data pertinent to a given application of the LLM (block 806). Subsequently, the method 800 involves the construction of an LLM (block 804) which encompasses pretraining with an attention mechanism (block 808), as well as the formulation of the model's architecture (block 810). The pretraining phase is undertaken to establish a foundational model (block 812) that learns from the prepared data, suited to the LLM's intended use. Within the foundational model (block 812), additional steps of training (block 814) and model evaluation (block 816) are performed. During this phase, the model may also benefit from pretrained weights (block 818), which can accelerate the training by drawing on previously acquired patterns and knowledge.

After the foundational model is established, the process includes finetuning (block 820), which is the calibration and optimization stage, utilizing more focused data pertaining to the specific application of the LLM. This phase is crucial for honing the LLM to produce accurate outcomes within its intended operational domain. Finally, an instructions dataset (block 824) is provided to the scoring system assistant (block 801). This dataset could contain structured instructions and prompts that facilitate the LLM in generating relevant analyses and responses. These prompts promote the practical implementation of the trained model, enabling it to function effectively as part of the scoring system assistant. FIG. 8A illustrates a structured approach for developing a specialized LLM aimed at a certain application, starting with data preparation and sampling, progressing through model construction with pretraining and architecture development, and culminating in the finetuning and deployment of a scoring system assistant that operates in conjunction with a dedicated instructions dataset. This visual aid encapsulates the sequence of steps necessary to forge a tool that supports the specific application for which the LLM is designed, according to some aspects.

The language learning model (LLM) outlined in method 800 directly supports the functions of the tech debt model training module 122 and the tech debt model operation module 124 within the computing environment. The LLM's initial steps of data preparation and sampling (block 806) align with the data collection and preparation activities of the tech debt model training module 122 to develop AI models that can accurately assess and manage technical debt. This module utilizes a variety of data sources, including code repositories, applications, and architecture diagrams to train neural network models and generative AI models.

The construction phase of the LLM, including pretraining with an attention mechanism (block 808) and the formulation of the model's architecture (block 810), parallels the development process within the tech debt model training module 122. This process involves using machine learning and data science libraries to build models capable of understanding and predicting technical debt patterns.

The foundational model (block 812) of the LLM, which undergoes additional training (block 814) and evaluation (block 816), reflects the iterative training and refinement process of AI models within the tech debt model training module 122. This module may leverage historical data and coding practices to enhance the accuracy and efficiency of the tech debt scoring process.

The finetuning stage (block 820) of the LLM is crucial for optimizing the model's performance for its specific application, mirroring the continuous improvement efforts of the tech debt model training module 122 to ensure the models remain relevant and accurate as the organization's technology landscape evolves.

Finally, the instructions dataset (block 824) provided to the scoring system assistant (block 801) enables the practical application of the LLM within the computing environment. This functionality is akin to the role of the tech debt model operation module 124, which applies trained AI models to new data to assess current technical debt and recommend actions for its reduction or management.

FIG. 8B illustrates a neural network-based model architecture for processing and analyzing data related to technological debt (block 852). The process begins with data collection (block 880) which is then passed through preprocessing layers, specifically a data normalization layer (block 862a) and a feature extraction layer (block 862b). These layers are followed by a dropout layer (block 864) to prevent overfitting. The core of the architecture is the neural network loop (block 866), which is iterated N times, where N is a positive integer. Each iteration consists of a normalization layer (block 870a), followed by an attention layer (block 872) with its own dropout layer (block 874a), another normalization layer (block 870b), a dense layer (block 876), and another dropout layer (block 874b). The process concludes with a final normalization layer (block 867) and a linear output layer (block 868), producing the final output from the neural network-based model. This architecture is designed to handle and analyze data for identifying and managing technological debt.

The model architecture depicted in FIG. 8B may be used to analyze and evaluate technological debt, particularly in the context of identifying inefficiencies, compliance gaps, and opportunities for modernization. This neural network-based architecture facilitates the processing of diverse data through a series of layers and loops designed to understand and identify patterns related to technological debt effectively. Initially, the collected data is processed through preprocessing layers, including normalization and feature extraction layers, which help the model understand the significance of each data point within the context of technological debt. This is crucial for effectively managing technological debt as it allows the system to grasp the nuances of the organization's technical environment, including outdated technologies, compliance issues, and potential areas for improvement. The dropout layers introduced after the preprocessing layers and within the neural network loop serve to prevent overfitting by randomly omitting some of the units from the layers during training. This ensures that the model does not become too reliant on the training data, allowing it to generalize better to new, unseen data. The neural network loop, iterated N times, is where the bulk of the analysis happens. Each iteration consists of a series of layers including normalization, attention, and dense layers, each followed by dropout layers. The normalization layers help stabilize the learning process, while the attention layers allow the model to focus on different parts of the input data to better understand the relationships between various factors contributing to technological debt. The dense layers, on the other hand, are fully connected layers that help in learning non-linear combinations of the features. The final normalization layer ensures that the data is normalized before passing it to the linear output layer, which produces the final output of the model.

Individuals can engage with the model to quantify and score of technical debt, leveraging the capabilities of a computing environment equipped with artificial intelligence, including language learning models (LLMs). These activities encompass collecting and analyzing data from diverse sources within a technology ecosystem, such as code repositories, application architecture diagrams, and process flows. By determining coding signals from coding practices, including code complexity and coding standards adherence, individuals can identify potential technical debt indicators. Interacting with an LLM, such as the LLM of FIG. 8A and FIG. 8B, individuals can refine the process of technical debt assessment by generating code, providing documentation, and summarizing technical documents, thereby enhancing productivity and code quality. For example, an LLM can be used to automate the generation of code snippets that adhere to best practices, reducing the likelihood of introducing new technical debt. Additionally, LLMs can interpret complex datasets and summarize technical documents, providing insights that inform the technical debt assessment process. The scoring system module 116 within the computing environment evaluates various aspects of technology and business inputs to produce a composite score or assessment of technical debt. This scoring process is supported by machine learning models, including neural networks and generative AI models, which are trained using structured and unstructured data from the organization's technology environment. The tech debt model training module plays a crucial role in developing and refining these AI models, using historical data, coding practices, and outcomes from previous assessments to improve the accuracy and efficiency of the tech debt scoring process. Furthermore, the tech debt model operation module applies the trained AI models to new data, enabling the system to assess current technical debt, predict future states, and recommend actions for debt reduction or management. This proactive management of technical debt is facilitated by the system's ability to integrate human feedback, ensuring continuous learning and adjustment of the assessment process.

### Exemplary Aspects

The various embodiments described above can be combined to provide further embodiments. All U.S. patents, U.S. patent application publications, U.S. patent application, foreign patents, foreign patent application and non-patent publications referred to in this specification and/or listed in the Application Data Sheet are incorporated herein by reference, in their entirety. Aspects of the embodiments can be modified if necessary to employ concepts of the various patents, applications, and publications to provide yet further embodiments.

These and other changes can be made to the embodiments in light of the above-detailed description. In general, in the following claims, the terms used should not be construed to limit the claims to the specific embodiments disclosed in the specification and the claims but should be construed to include all possible embodiments along with the full scope of equivalents to which such claims are entitled. Accordingly, the claims are not limited by the disclosure.

Aspects of the techniques described in the present disclosure may include any of the following aspects, either alone or in combination:
1. A computing system for evaluating and managing technical debt within a technology ecosystem, the system comprising: one or more processors; and one or more memories storing instructions that, when executed by the processor, cause the system to: collect, via the one or more processors, data from a technology ecosystem, including software and hardware platforms, tools, and processes; determine, via the one or more processors, coding signals from coding practices, including code complexity and coding standards adherence; receive, via the one or more processors, inputs from one or both of (i) a technical debt assessment system and (ii) an organizational redesign system, to inform a technology ecosystem assessment; determine, via the one or more processors, business capabilities including functional abilities and processes of a business; evaluate, via the one or more processors, the collected data, derived coding signals, inputs, and business capabilities using a scoring system; and generate a tech debt score based on the evaluation, wherein the tech debt score represents the technical debt of the technology ecosystem.
2. The computing system of aspect 1, wherein the technology ecosystem data collection further comprises analyzing application architecture diagrams and process flows against a well-architected framework and technology ecosystem guidelines.
3. The computing system of any of aspects 1-2, wherein the derived coding signals further include analysis of scalability, security, and other factors defining the technical debt score.
4. The computing system of any of aspects 1-3, further comprising instructions that enable the system to use artificial intelligence to forecast and predict the desired technical debt score and timeline based on the initial evaluation.
5. The computing system of any of aspects 1-4, further comprising instructions that enable the system to integrate human feedback for continuous learning and adjustment of the technical debt assessment process.
6. The computing system of any of aspects 1-5, further comprising instructions that enable the system to incorporate domain information, regulatory information, and strategic insights to understand the business impact of technical debt.
7. The computing system of any of aspects 1-6, further comprising instructions that enable the system to classify technical debt scores by application and business function, providing business insights and actions for business units.
8. A method for evaluating and managing technical debt within a technology ecosystem, the method comprising: collecting, by one or more processors, data from a technology ecosystem, including software and hardware platforms, tools, and processes; determining, by the one or more processors, coding signals from coding practices, including code complexity and coding standards adherence; receiving, by the one or more processors, inputs from one or both of (i) a technical debt assessment system and (ii) an organizational redesign system, to inform a technology ecosystem assessment; determining, by the one or more processors, business capabilities including functional abilities and processes of a business; evaluating, by the one or more processors, the collected data, derived coding signals, inputs, and business capabilities using a scoring system; and generating, by the one or more processors, a tech debt score based on the evaluation, wherein the tech debt score represents the technical debt of the technology ecosystem.
9. The method of aspect 8, wherein collecting data from the technology ecosystem further comprises analyzing application architecture diagrams and process flows against a well-architected framework and technology ecosystem guidelines.
10. The method of any of aspects 8-9, wherein determining coding signals further includes analysis of scalability, security, and other factors defining the technical debt score.
11. The method of any of aspects 8-10, further comprising using artificial intelligence, by the one or more processors, to forecast and predict the desired technical debt score and timeline based on the initial evaluation.
12. The method of any of aspects 8-11, further comprising integrating human feedback, by the one or more processors, for continuous learning and adjustment of the technical debt assessment process.
13. The method of any of aspects 8-12, further comprising incorporating, by the one or more processors, domain information, regulatory information, and strategic insights to understand the business impact of technical debt.
14. The method of any of aspects 8-13, further comprising classifying, by the one or more processors, technical debt scores by application and business function, providing business insights and actions for business units.
15. A non-transitory computer-readable medium having stored thereon instructions that, when executed by one or more processors of a computing system, cause the system to perform operations comprising: collecting data from a technology ecosystem, including software and hardware platforms, tools, and processes; determining coding signals from coding practices, including code complexity and coding standards adherence; receiving inputs from one or both of (i) a technical debt assessment system and (ii) an organizational redesign system, to inform a technology ecosystem assessment; determining business capabilities including functional abilities and processes of a business; evaluating the collected data, derived coding signals, inputs, and business capabilities using a scoring system; and generating a tech debt score based on the evaluation, wherein the tech debt score represents the technical debt of the technology ecosystem.
16. The computer-readable medium of aspect 15, wherein the operations further comprise analyzing application architecture diagrams and process flows against a well-architected framework and technology ecosystem guidelines as part of the data collection.
17. The computer-readable medium of any of aspects 15-16, wherein the operations further comprise including analysis of scalability, security, and other factors defining the technical debt score in the determination of coding signals.
18. The computer-readable medium of any of aspects 15-17, wherein the operations further comprise using artificial intelligence to forecast and predict the desired technical debt score and timeline based on the initial evaluation.
19. The computer-readable medium of any of aspects 15-18, wherein the operations further comprise integrating human feedback for continuous learning and adjustment of the technical debt assessment process.
20. The computer-readable medium of any of aspects 15-19, wherein the operations further comprise incorporating domain information, regulatory information, and strategic insights to understand the business impact of technical debt and classifying technical debt scores by application and business function, providing business insights and actions for business units.

### Additional Considerations

The following considerations also apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

It should also be understood that, unless a term is expressly defined in this patent using the sentence “As used herein, the term” “is hereby defined to mean.” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112(f).

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” is employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for implementing the concepts disclosed herein, through the principles disclosed herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

1. A computing system for evaluating and managing technical debt within a technology ecosystem, the system comprising:
one or more processors; and
one or more memories storing instructions that, when executed by the one or more processors, cause the system to:
collect, via the one or more processors, data from a technology ecosystem, including software and hardware platforms, tools, and processes;
clean, normalize, and categorize the data from the technology ecosystem to identify and retain only data points relevant to technical debt assessment;
determine, via the one or more processors, coding signals from code quality metrics and business capabilities;
receive, via the one or more processors, inputs from one or both of (i) a technical debt assessment system and (ii) an organizational redesign system, to inform a technology ecosystem assessment;
apply, via the one or more processors, a neural network to the collected data to identify non-linear relationships between the coding signals and the business capabilities;
evaluate, via the one or more processors, the collected data, the coding signals, the inputs, and the business capabilities using a scoring system; and
generate a technical debt score based on the evaluation, wherein the technical debt score represents the technical debt of the technology ecosystem.

2. The computing system of claim 1, wherein the technology ecosystem data collection further comprises analyzing application architecture diagrams and process flows against a well-architected framework and technology ecosystem guidelines.

3. The computing system of claim 1, wherein the coding signals further include analysis of scalability, security, and other factors defining the technical debt score.

4. The computing system of claim 1, further comprising instructions that enable the system to use artificial intelligence to forecast and predict a desired technical debt score and timeline based on the evaluation.

5. The computing system of claim 1, further comprising instructions that enable the system to integrate human feedback for continuous learning and adjustment of the technical debt assessment process.

6. The computing system of claim 1, further comprising instructions that enable the system to incorporate domain information, regulatory information, and strategic insights to understand a business impact of technical debt.

7. The computing system of claim 1, further comprising instructions that enable the system to classify the technical debt score by application and business function, providing business insights and actions for business units.

8. A method for evaluating and managing technical debt within a technology ecosystem, the method comprising:
training, by one or more processors, a neural network model using historical data comprising past practices and outcomes from previous technical debt assessments;
assigning, by the one or more processors, weighted scores to different coding signals based on their historical impact on technical debt accumulation;
collecting, by the one or more processors, data from a technology ecosystem, including software and hardware platforms, tools, and processes;
cleaning, normalizing, and categorizing the data from the technology ecosystem to identify and retain only data points relevant to technical debt assessment;
determining, by the one or more processors, coding signals from code quality metrics and business capabilities;
receiving, by the one or more processors, inputs from one or both of (i) a technical debt assessment system and (ii) an organizational redesign system, to inform a technology ecosystem assessment;
applying, by the one or more processors, a neural network to the collected data to identify non-linear relationships between the coding signals and the business capabilities;
evaluating, by the one or more processors, the collected data, the coding signals, the inputs, and the business capabilities using a scoring system; and
generating, by the one or more processors, a technical debt score based on the evaluation, wherein the technical debt score represents the technical debt of the technology ecosystem.

9. The method of claim 8, wherein collecting data from the technology ecosystem further comprises analyzing application architecture diagrams and process flows against a well-architected framework and technology ecosystem guidelines.

10. The method of claim 8, wherein determining coding signals further includes analysis of scalability, security, and other factors defining the technical debt score.

11. The method of claim 8, further comprising using artificial intelligence, by the one or more processors, to forecast and predict a desired technical debt score and timeline based on the evaluation.

12. The method of claim 8, further comprising integrating human feedback, by the one or more processors, for continuous learning and adjustment of the technical debt assessment process.

13. The method of claim 8, further comprising incorporating, by the one or more processors, domain information, regulatory information, and strategic insights to understand the business impact of technical debt.

14. The method of claim 8, further comprising classifying, by the one or more processors, technical debt scores by application and business function, providing business insights and actions for business units.

15. A non-transitory computer-readable medium having stored thereon instructions that, when executed by one or more processors of a computing system, cause the system to perform operations comprising:
collecting data from a technology ecosystem, including software and hardware platforms, tools, and processes;
cleaning, normalizing, and categorizing the data from the technology ecosystem to identify and retain only data points relevant to technical debt assessment;
determining coding signals from code quality metrics and business capabilities;
receiving inputs from one or both of (i) a technical debt assessment system and (ii) an organizational redesign system, to inform a technology ecosystem assessment;
applying a neural network to the collected data to identify non-linear relationships between the coding signals and the business capabilities;
evaluating the collected data, the coding signals, the inputs, and the business capabilities using a scoring system; and
generating a technical debt score based on the evaluation, wherein the technical debt score represents the technical debt of the technology ecosystem.

16. The computer-readable medium of claim 15, wherein the operations further comprise analyzing application architecture diagrams and process flows against a well-architected framework and technology ecosystem guidelines as part of the data collection.

17. The computer-readable medium of claim 15, wherein the operations further comprise including analysis of scalability, security, and other factors defining the technical debt score in the determination of coding signals.

18. The computer-readable medium of claim 15, wherein the operations further comprise using artificial intelligence to forecast and predict a desired technical debt score and timeline based on the initial evaluation.

19. The computer-readable medium of claim 15, wherein the operations further comprise integrating human feedback for continuous learning and adjustment of the technical debt assessment process.

20. The computer-readable medium of claim 15, wherein the operations further comprise incorporating domain information, regulatory information, and strategic insights to understand a business impact of technical debt and classifying technical debt scores by application and business function, providing business insights and actions for business units.
